(19) United States
(12) Patent Application Publication
(10) Pub. No.: US 2024/0020877 A1
(43) Pub. Date: Jan. 18, 2024

(54) DETERMINING INTERVENTIONAL DEVICE POSITION

(71) Applicant: KONINKLIJKE PHILIPS N.V., EINDHOVEN (NL)

(72) Inventors: ASHISH SATTYAVRAT PANSE, BURLINGTON, MA (US); AYUSHI SINHA, BALTIMORE, MD (US); GRZEGORZ ANDRZEJ TOPOREK, CAMBRIDGE, MA (US)

(21) Appl. No.: 18/036,423

(22) PCT Filed: Nov. 18, 2021
(86) PCT No.: PCT/EP2021/082056

§ 371 Date: May 11, 2023

Related U.S. Application Data
(60) Provisional application No. 63/117,543, filed on Nov. 24, 2020.

(51) Int. Cl. G06T 7/73; G06T 7/55

(52) U.S. Cl. CPC G06T 7/74; G06T 7/55; G06T 2207/10081; G06T 2207/10116; G06T 2207/20081; G06T 2207/20084; G06T 2207/10132; G06T 2207/10088

(57) ABSTRACT

A computer-implemented method of providing a neural network for predicting a position of each of a plurality of portions of an interventional device (100), includes training (S130) a neural network (130) to predict, from temporal shape data (110) representing a shape of the interventional device (100) at one or more historic time steps i(t₁ . . . tₙ₋₁) in a sequence, a position (140) of each of the plurality of portions of the interventional device (100) at a current time step (tₙ) in the sequence.

### TECHNICAL FIELD

The present disclosure relates to determining positions of portions of an interventional device. A computer-implemented method, a processing arrangement, a system, and a computer program product, are disclosed.

### BACKGROUND

Many interventional medical procedures are carried out under live X-ray imaging. The two-dimensional images generated during live X-ray imaging assist physicians by providing a visualization of both the anatomy, and interventional devices such as guidewires and catheters that are used in the procedure.

By way of an example, endovascular procedures require interventional devices to be navigated to specific locations in the cardiovascular system. Navigation often begins at a femoral, brachial, radial, jugular, or pedal access point, from which the interventional device passes through the vasculature to a location where imaging, or a therapeutic procedure, is performed. The vasculature typically has high inter-patient variability, moreso when diseased, and can hamper navigation of the interventional device. For example, navigation from an abdominal aortic aneurysm through the ostium of a renal vessel may be challenging because the aneurysm reduces the ability to use the vessel wall to assist in the device positioning and cannulation.

During such procedures, portions of interventional devices such as such as guidewires and catheters may become obscured or even invisible under X-ray imaging, further hampering navigation of the interventional device. An interventional device may for example be hidden behind dense anatomy. X-ray-transparent sections of the interventional device, and image artifacts may also confound a determination of the path of the interventional device within the anatomy.

Various techniques have been developed to address these drawbacks, including the use of radiopaque fiducial markers on the interventional device, and the interpolation of segmented images. However, there remains room for improvements in determining the position of interventional devices under X-ray imaging.

### SUMMARY

According to a first aspect of the present disclosure, a computer-implemented method of providing a neural network for predicting a position of each of a plurality of portions of an interventional device is provided. The method includes:
receiving temporal shape data representing a shape of an interventional device at a sequence of time steps t₁ . . . tₙ;
receiving S12 interventional device ground truth position data representing a position of each of a plurality of portions of the interventional device at each time step in the sequence; and
training a neural network to predict, from the temporal shape data representing a shape of the interventional device at one or more historic time steps in the sequence, a position of each of the plurality of portions of the interventional device at a current time step in the sequence, by, for each current time step in the sequence, inputting the received temporal shape data representing a shape of the interventional device at one or more historic time steps in the sequence into the neural network, and adjusting parameters of the neural network based on a loss function representing a difference between the predicted position of each portion of the interventional device at the current time step, and the position of each corresponding portion of the interventional device 100 at the current time step from the received interventional device ground truth position data.

According to a second aspect of the present disclosure, a computer-implemented method of predicting a position of each of a plurality of portions of an interventional device is provided. The method includes:
receiving temporal shape data representing a shape of an interventional device at a sequence of time steps; and
inputting the received temporal shape data representing a shape of the interventional device at one or more historic time steps in the sequence, into a neural network trained to predict, from the temporal shape data representing a shape of the interventional device at one or more historic time steps in the sequence, a position of each of the plurality of portions of the interventional device at a current time step in the sequence, and in response to the inputting, generating a predicted position of each of the plurality of portions of the interventional device at the current time step in the sequence, using the neural network.

Further aspects, features and advantages of the present disclosure will become apparent from the following description of examples, which is made with reference to the accompanying drawings.

### BRIEF DESCRIPTION OF THE DRAWINGS

FIG. 1 illustrates an X-ray image of the human anatomy, including a catheter and the tip of a guidewire.

FIG. 2 is a flowchart of an example method of providing a neural network for predicting positions of portions of an interventional device, in accordance with some aspects of the disclosure.

FIG. 3 is a schematic diagram illustrating an example method of providing a neural network for predicting positions of portions of an interventional device, in accordance with some aspects of the disclosure.

FIG. 4 is a schematic diagram illustrating an example LSTM cell.

FIG. 5 is a flowchart illustrating an example method of predicting positions of portions of an interventional device, in accordance with some aspects of the disclosure.

FIG. 6 illustrates an X-ray image of the human anatomy, including a catheter and a guidewire, and wherein the predicted position of an otherwise invisible portion of the guidewire is displayed.

FIG. 7 is a schematic diagram illustrating a system 200 for predicting positions of portions of an interventional device.

### DETAILED DESCRIPTION

Examples of the present disclosure are provided with reference to the following description and the figures. In this description, for the purposes of explanation, numerous specific details of certain examples are set forth. Reference in the specification to “an example”, “an implementation” or similar language means that a feature, structure, or characteristic described in connection with the example is included in at least that one example. It is also to be appreciated that features described in relation to one example may also be used in another example, and that all features are not necessarily duplicated in each example for the sake of brevity. For instance, features described in relation to a computer-implemented method may be implemented in a processing arrangement, and in a system, and in a computer program product, in a corresponding manner.

In the following description, reference is made to computer implemented methods that involve predicting a position of an interventional device within the vasculature. Reference is made to a live X-ray imaging procedure wherein an interventional device in the form of a guidewire is navigated within the vasculature. However, it is to be appreciated that examples of the computer implemented methods disclosed herein may be used with other types of interventional devices than a guidewire, such as, and without limitation: a catheter, an intravascular ultrasound imaging device, an optical coherence tomography device, an introducer sheath, a laser atherectomy device, a mechanical atherectomy device, a blood pressure device and/or flow sensor device, a TEE probe, a needle, a biopsy needle, an ablation device, a balloon, or an endograft, and so forth. It is also to be appreciated that examples of the computer implemented methods disclosed herein may be used with other types of imaging procedures, such as, and without limitation: computed tomographic imaging, ultrasound imaging, and magnetic resonance imaging. It is also to be appreciated that examples of the computer implemented methods disclosed herein may be used with interventional devices that, as appropriate, are disposed in other anatomical regions than the vasculature, including and without limitation, the digestive tract, respiratory pathways, the urinary tract, and so forth.

It is noted that the computer-implemented methods disclosed herein may be provided as a non-transitory computer-readable storage medium including computer-readable instructions stored thereon which, when executed by at least one processor, cause the at least one processor to perform the method. In other words, the computer-implemented methods may be implemented in a computer program product. The computer program product can be provided by dedicated hardware or hardware capable of running the software in association with appropriate software. When provided by a processor or “processing arrangement”, the functions of the method features can be provided by a single dedicated processor, by a single shared processor, or by a plurality of individual processors, some of which can be shared. The explicit use of the terms “processor” or “controller” should not be interpreted as exclusively referring to hardware capable of running software, and can implicitly include, but is not limited to, digital signal processor “DSP” hardware, read only memory “ROM” for storing software, random access memory “RAM”, a non-volatile storage device, and the like. Furthermore, examples of the present disclosure can take the form of a computer program product accessible from a computer usable storage medium or a computer-readable storage medium, the computer program product providing program code for use by or in connection with a computer or any instruction execution system. For the purposes of this description, a computer-usable storage medium or computer-readable storage medium can be any apparatus that can comprise, store, communicate, propagate, or transport a program for use by or in connection with an instruction execution system, apparatus, or device. The medium can be an electronic, magnetic, optical, electromagnetic, infrared, or semiconductor system or device or device or propagation medium. Examples of computer-readable media include semiconductor or solid-state memories, magnetic tape, removable computer disks, random access memory “RAM”, read only memory “ROM”, rigid magnetic disks, and optical disks. Current examples of optical disks include compact disk-read only memory “CD-ROM”, optical disk-read/write “CD-R/W”, Blu-Ray™, and DVD.

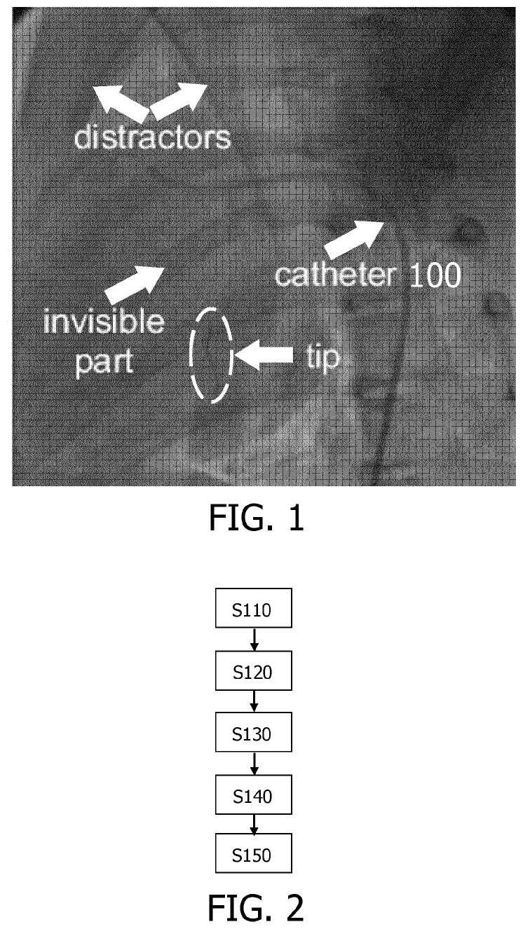

FIG. 1 illustrates an X-ray image of the human anatomy, including a catheter and the tip of a guidewire. In FIG. 1, dense regions of the anatomy such as the ribs are highly visible as darker regions in the image. The catheter, and the tip of a guidewire extending therefrom, are also highly visible. However, soft tissue regions such as the vasculature are poorly visible and thus offer little guidance during navigation under X-ray imaging. Image artifacts labelled as “distractors” in FIG. 1, as well as other features in the X-ray image that appear similar to the guidewire, may also hamper clear visualization of the guidewire in the X-ray image. A further complication is that under X-ray imaging, some portions of the guidewire, may be poorly visible. For example, although the tip of the guidewire is clearly visible in FIG. 1, portions of the guidewire are poorly, or even completely invisible, such as the portion labelled “invisible part”. The visibility of portions of other interventional devices may likewise be impaired when imaged by X-ray, and other, imaging systems.

The inventors have found an improved method of determining positions of portions of an interventional device. FIG. 2 is a flowchart of an example method of providing a neural network for predicting positions of portions of an interventional device, in accordance with some aspects of the disclosure. The method is described with reference to FIG. 2-FIG. 4. With reference to FIG. 2, the method includes providing a neural network for predicting a position of each of a plurality of portions of an interventional device 100, and includes:
receiving 5110 temporal shape data 110 representing a shape of an interventional device 100 at a sequence of time steps t₁ . . . tₙ;
receiving 5120 interventional device ground truth position data 120 representing a position of each of a plurality of portions of the interventional device 100 at each time step t₁ . . . tₙ in the sequence; and
training 5130 a neural network 130 to predict, from the temporal shape data 110 representing a shape of the interventional device 100 at one or more historic time steps t₁ . . . tₙ₋₁ in the sequence, a position 140 of each of the plurality of portions of the interventional device 100 at a current time step tₙ in the sequence, by, for each current time step tn in the sequence, inputting S140 the received temporal shape data 110 representing a shape of the interventional device 100 at one or more historic time steps t₁ . . . tₙ₋₁ in the sequence into the neural network 130, and adjusting 5150 parameters of the neural network 130 based on a loss function representing a difference between the predicted position 140 of each portion of the interventional device 100 at the current time step tn, and the position of each corresponding portion of the interventional device 100 at the current time step tₙ from the received interventional device ground truth position data 120.

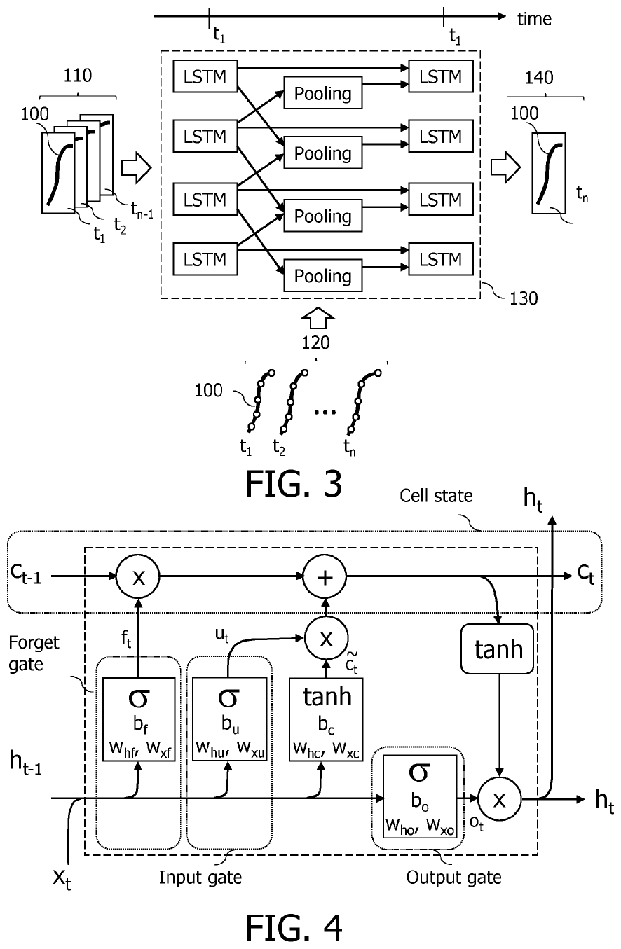

FIG. 3 is a schematic diagram illustrating an example method of providing a neural network for predicting positions of portions of an interventional device, in accordance with some aspects of the disclosure. FIG. 3 includes a neural network 130 that includes a plurality of long short term memory, LSTM, cells. The operation of each LSTM cell is described below with reference to FIG. 4.

With reference to FIG. 3, during training operation S130, temporal shape data 110, which may for example be in the form of a temporal sequence of segmented X-ray images generated at time steps t₁ . . . tₙ₋₁, is inputted into the neural network 130. The X-ray images include interventional device 100, which in the illustrated image is a guidewire. The X-ray images represent a shape of the guidewire at each time steps ti..tn. Various known segmentation techniques may be used to extract the shape of the interventional device, or guidewire, from the X-ray images. Segmentation techniques such as those disclosed in a document by Honnorat, N., et al., entitled “Robust guidewire segmentation through boosting, clustering and linear programming”, 2010 IEEE International Symposium on Biomedical Imaging: From Nano to Macro, Rotterdam, 2010, pp. 924-927, may for example be used. The X-ray images provide the shape of the guidewire in two dimensions. Portions of the guidewire may then be identified, for example by defining groups of one or more pixels on the guidewire in the X-ray images. The portions may be defined arbitrarily, or at regular intervals along the guidewire length. In so doing, the position of each portion of the guidewire may be provided in two dimensions at each time step t₁ . . . tₙ.

In general, the temporal shape data 110 may include: a temporal sequence of X-ray images including the interventional device 100; or a temporal sequence of computed tomography images including the interventional device 100; or a temporal sequence of ultrasound images including the interventional device 100; or a temporal sequence of magnetic resonance images including the interventional device (100); or a temporal sequence of positions provided by a plurality of electromagnetic tracking sensors or emitters mechanically coupled to the interventional device 100; or a temporal sequence of positions provided by a plurality of fiber optic shape sensors mechanically coupled to the interventional device 100; or a temporal sequence of positions provided by a plurality of dielectric sensors mechanically coupled to the interventional device 100; or a temporal sequence of positions provided by a plurality of ultrasound tracking sensors or emitters mechanically coupled to the interventional device 100. Thus, it is also contemplated to provide the temporal shape data 110 as three-dimensional shape data.

Simultaneously with the generation of the X-ray images at time steps t₁ . . . tₙ₋₁, corresponding interventional device ground truth position data 120 representing a position of each of a plurality of portions of the interventional device 100 at each time step ti..tn in the sequence, may also be generated. The interventional device ground truth position data 120 serves as training data. In the illustrated example in FIG. 3, the ground truth position data 120 is provided by the same X-ray image data that is used to provide the temporal shape data 130. Thus, it is contemplated to provide the ground truth position data as two-dimensional position data. Moreover, the same positions of the guidewire may be used to provide both the ground truth position data 120 and the temporal shape data 110 at each time step ti..tn.

It is also contemplated to provide the ground truth position data 120 from other sources. In some implementations, the ground truth position data 120 may originate from a different source that of the temporal shape data 110. The ground truth position data 120 may for example be provided by a temporal sequence of computed tomography images including the interventional device 100. Thus, it is also contemplated to provide the ground truth position data as three-dimensional position data. The computed tomography images may for example be cone beam computed tomography, CBCT, or spectral computed tomography images. The ground truth position data 120 may alternatively be provided by a temporal sequence of ultrasound images including the interventional device 100, or indeed a temporal sequence of images from another imaging modality such as magnetic resonance imaging.

In other implementations, the ground truth position data 120 may be provided by tracked sensors or emitters mechanically coupled to the interventional device. In this respect, electromagnetic tracking sensors or emitters such as those disclosed in document WO 2015/165736 A1, or fiber optic shape sensors such as those disclosed in document W02007/109778 A1, dielectric sensors such as those disclosed in document US 2019/254564 A1, or ultrasound tracking sensors or emitters such as disclosed in document WO 2020/030557 A1, may be mechanically coupled to the interventional device 100 and used to provide a temporal sequence of positions that correspond to the position of each sensor or emitter at each time step t₁ . . . tₙ in in the sequence.

When the ground truth position data 120 is provided by a different source to that of the temporal shape data 110, the coordinate system of the ground truth position data 120 may be registered to the coordinate system of the temporal shape data 110 in order to facilitate computation of the loss function.

The temporal shape data 110, and the ground truth position data 120 may be received from various sources, including a database, an imaging system, a computer readable storage medium, the cloud, and so forth. The data may be received using any form of data communication, such as wired or wireless data communication, and may be via the internet, an ethernet, or by transferring the data by means of a portable computer-readable storage medium such as a USB memory device, an optical or magnetic disk, and so forth.

Returning to FIG. 3, the neural network 130 is then trained to predict, from the temporal shape data 110 in the form of a temporal sequence of X-ray images at one or more historic time steps t₁ . . . tₙ₋₁ a position 140 of each of the plurality of portions of the interventional device 100 at a current time step tₙ in the sequence. The training of the neural network 130 in FIG. 3 may be carried out in a manner described in more detail in a document by Alahi, A., et al entitled “Social LSTM: Human Trajectory Prediction in Crowded Spaces”, 2016 IEEE Conference on Computer Vision and Pattern Recognition “CVPR”, 10.1109/CVPR.2016.110. The input to the neural network 130 is a position of each of multiple portions of the interventional device. For each portion of the interventional device, an LSTM cell predicts, using the positions of that portion from one or more historic time steps t₁ . . . tₙ₋₁, a position of the portion in the current time step tn.

In some implementations, the neural network 130 includes multiple outputs, and each output predicts a position 140 of a different portion of the interventional device 100 at the current time step tₙ in the sequence. In the neural network 130 illustrated in FIG. 3, training is performed by inputting the positions of each portion of the interventional device from one or more historic time steps t₁ . . . tₙ₋₁, into the neural network, and adjusting the parameters of the neural network using a loss function representing a difference between the predicted position 140 of each portion of the interventional device 100 at the current time step tₙ, and the position of each corresponding portion of the interventional device 100 at the current time step tₙ, from the received interventional device ground truth position data 120. In these implementations, each output of the neural network 130 may, as illustrated in FIG. 3, include a corresponding input, which is configured to receive temporal shape data (110) representing a shape of the interventional device (100) in the form of a position of the portion of the interventional device at the one or more historic time steps (t₁ . . . tₙ₋₁) in the sequence. As mentioned above, the positions of portions of the guidewire may for example be identified from the inputted X-ray images 110 by defining groups of one or more pixels on the guidewire in the segmented X-ray images.

In more detail, the neural network 130 illustrated in FIG. 3, includes multiple outputs, and each output predicts the position (140) of the different portion of the interventional device (100) at the current time step (tn) in the sequence, based at least in part on the predicted position of one or more neighbouring portions of the interventional device (100) at the current time step (tₙ). This functionality is provided by the Pooling layer, which allows for sharing of information in the hidden states between neighboring LSTM cells. This captures the influence of neighboring portions of the device on the motion of the portion of the device being predicted. This improves the accuracy of the prediction because it preserves position information about neighboring portions of the interventional device, and thus the continuity of the interventional device shape. The extent of the neighborhood; i.e. the number of neighboring portions, and the range within which the positions of neighboring portions are used in predicting the position of a portion of the interventional device, may range between immediate neighboring portions to the entire interventional device. The extent of the neighborhood may also depend on the flexibility of the device. For example, a rigid device may use a relatively larger neighborhood where as a flexible device may use a relatively smaller neighborhood. Alternatives to the illustrated Pooling layer include applying constraints to the output of the neural network by eliminating predicted positions which violate the continuity of the device, or which predict a curvature of the interventional device that exceeds a predetermined value.

In some implementations, the neural network illustrated in FIG. 3 may be provided by LSTM cells. For example, each block labelled as LSTM in FIG. 3 may be provided by an LSTM cell such as that illustrated in FIG. 4. The position of each portion of the interventional device may be predicted by an LSTM cell. However, the functionality of the items labelled LSTM may be provided by other types of neural network to an LSTM. The functionality of the items labelled LSTM may for example be provided by a recurrent neural network, RNN, a convolutional neural network, CNN, a temporal convolutional neural network, TCN, and a transformer.

The training operation 5130 involves adjusting 5150 parameters of the neural network 130 based on a loss function representing a difference between the predicted position 140 of each portion of the interventional device 100 at the current time step tₙ, and the position of each corresponding portion of the interventional device 100 at the current time step tn from the received interventional device ground truth position data 120.

The training operation 5130 is described in more detail with reference to FIG. 4, which is a schematic diagram illustrating an example LSTM cell. The LSTM cell illustrated in FIG. 4 may be used to implement the LSTM cells in FIG. 3. With reference to

FIG. 4, the LSTM cell includes three inputs: hₜ₋₁, cₜ₋₁ and xₜ, and two outputs: hₜ and cₜ. The sigma and tanh labels respectively represent sigmoid and tanh activation functions, and the “x” and the “+” symbols respectively represent pointwise multiplication and pointwise addition operations. At time, t, output hₜ represents the hidden state, output ct represents the cell state, and input xₜ represents the current data input. Moving from left to right in FIG. 4, the first sigmoid activation function provides a forget gate. Its inputs: hₜ₋₁ and xₜ, respectively representing the hidden state of the previous cell, and the current data input, are concatenated and passed through a sigmoid activation function. The output of the sigmoid activation function is then multiplied by the previous cell state, cₜ₋₁. The forget gate controls the amount of information from the previous cell that is to be included in the current cell state ct. Its contribution is included via the pointwise addition represented by the “+” symbol. Moving towards the right in FIG. 1, the input gate controls the updating of the cell state cₜ. The hidden state of the previous cell, hₜ₋₁, and the current data input, xₜ, are concatenated and passed through a sigmoid activation function, and also through a tanh activation function. The pointwise multiplication of the outputs of these functions determines the amount of information that is to be added to the cell state via the pointwise addition represented by the “+” symbol. The result of the pointwise multiplication is added to the output of the forget gate multiplied by the previous cell state cₜ₋₁, to provide the current cell state cₜ. Moving further towards the right in FIG. 1, the output gate determines what the next hidden state, hₜ, should be. The hidden state includes information on previous inputs, and is used for predictions. To determine the next hidden state, h t , the hidden state of the previous cell, hₜ₋₁, and the current data input, xₜ, are concatenated and passed through a sigmoid activation function. The new cell state, cₜ, is passed through a tanh activation function. The outputs of the tanh activation function and the sigmoid activation function are then multiplied to determine the information in the next hidden state, hₜ.

As in other neural networks, the training of the LSTM cell illustrated in FIG. 4, and thus the neural network in which it may be used, is performed by adjusting parameters, or in other words, weights and biases. With reference to FIG. 4, the lower four activation functions in FIG. 4 are controlled by weights and biases. These are identified in FIG. 4 by means of the symbols w, and b. In the illustrated LSTM cell, each of these four activation functions typically includes two weight values, i.e. one for each x t input, and one for each hₜ₋₁ input, and one bias value, b. Thus, the example LSTM cell illustrated in FIG. 4 typically includes 8 weight parameters, and 4 bias parameters.

The operation of the LSTM cell illustrated in FIG. 4 is thus controlled by the following equations:

fₜ=σ((w_{hf}×hₜ₋₁)+(w_{xf}×xₜ)+b_{f}) Equation 1

uₜ=σ((wₕᵤ×hₜ₋₁)+(wₓᵤ×xₜ)+bᵤ) Equation 2

c\tilde{ }ₜ=tan h ((w_{hc}×hₜ₋₁)+(w_{xc}×xₜ)+b_{c}) Equation 3

oₜ=σ((wₕₒ×hₜ₋₁)+(wₓₒ×xₜ)+bₒ) Equation 4

cₜ=[c\tilde{ }ₜ+uₜ]+[cₜ₋₁+fₜ] Equation 5

yₜ=[oₜ×tan h cₜ] Equation 6

Training neural networks that include the LSTM cell illustrated in FIG. 4, and other neural networks, therefore involves adjusting the weights and the biases of activation functions. Supervised learning involves providing a neural network with a training dataset that includes input data and corresponding expected output data. The training dataset is representative of the input data that the neural network will likely be used to analyses after training. During supervised learning, the weights and the biases are automatically adjusted such that when presented with the input data, the neural network accurately provides the corresponding expected output data.

Training a neural network typically involves inputting a large training dataset into the neural network, and iteratively adjusting the neural network parameters until the trained neural network provides an accurate output. Training is usually performed using a Graphics Processing Unit “GPU” or a dedicated neural processor such as a Neural Processing Unit “NPU” or a Tensor Processing Unit “TPU”. Training therefore typically employs a centralized approach wherein cloud-based or mainframe-based neural processors are used to train a neural network. Following its training with the training dataset, the trained neural network may be deployed to a device for analyzing new input data; a process termed “inference”. The processing requirements during inference are significantly less than those required during training, allowing the neural network to be deployed to a variety of systems such as laptop computers, tablets, mobile phones and so forth. Inference may for example be performed by a Central Processing Unit “CPU”, a GPU, an NPU, a TPU, on a server, or in the cloud.

As outlined above, the process of training a neural network includes adjusting the above-described weights and biases of activation functions. In supervised learning, the training process automatically adjusts the weights and the biases, such that when presented with the input data, the neural network accurately provides the corresponding expected output data. The value of a loss function, or error, is computed based on a difference between the predicted output data and the expected output data. The value of the loss function may be computed using functions such as the negative log-likelihood loss, the mean squared error, or the Huber loss, or the cross entropy. During training, the value of the loss function is typically minimized, and training is terminated when the value of the loss function satisfies a stopping criterion. Sometimes, training is terminated when the value of the loss function satisfies one or more of multiple criteria.

Various methods are known for solving the loss minimization problem such as gradient descent, Quasi-Newton methods, and so forth. Various algorithms have been developed to implement these methods and their variants including but not limited to Stochastic Gradient Descent “SGD”, batch gradient descent, mini-batch gradient descent, Gauss-Newton, Levenberg Marquardt, Momentum, Adam, Nadam, Adagrad, Adadelta, RMSProp, and Adamax “optimizers” These algorithms compute the derivative of the loss function with respect to the model parameters using the chain rule. This process is called backpropagation since derivatives are computed starting at the last layer or output layer, moving toward the first layer or input layer. These derivatives inform the algorithm how the model parameters must be adjusted in order to minimize the error function. That is, adjustments to model parameters are made starting from the output layer and working backwards in the network until the input layer is reached. In a first training iteration, the initial weights and biases are often randomized. The neural network then predicts the output data, which is likewise, random. Backpropagation is then used to adjust the weights and the biases. The training process is performed iteratively by making adjustments to the weights and biases in each iteration. Training is terminated when the error, or difference between the predicted output data and the expected output data, is within an acceptable range for the training data, or for some validation data. Subsequently the neural network may be deployed, and the trained neural network makes predictions on new input data using the trained values of its parameters. If the training process was successful, the trained neural network accurately predicts the expected output data from the new input data.

It is to be appreciated that the example LSTM neural network described above with reference to FIG. 3 and FIG. 4 serves only as an example, and other neural networks may likewise be used to implement the functionality of the above-described method. Alternative neural networks to the LSTM neural network 130 may also be trained in order to perform the desired prediction during the training operation 5130, including and without limitation: a recurrent neural network, RNN, a convolutional neural network, CNN, a temporal convolutional neural network, TCN, and a transformer.

In some implementations, the training of the neural network in operation S130 is further constrained. In one example implementation, the temporal shape data 110, or the interventional device ground truth position data 120, comprises a temporal sequence of X-ray images including the interventional device 100; and the interventional device 100 is disposed in a vascular region. In this example, the above-described method further includes:
extracting S160, from the temporal shape data 110, or the interventional device ground truth position data 120, vascular image data representing a shape of the vascular region;
and training 5130 a neural network 130 further comprises:
constraining the adjusting S150 such that the predicted position 140 of each of the plurality of portions of the interventional device 100 at the current time step to in the sequence, fits within the shape of the vascular region represented by the extracted vascular image data.

In so doing, the position of the portions of the interventional device may be predicted with higher accuracy. The constraint may be applied by computing a second loss function based on the constraint, and incorporating this second loss function, together with the aforementioned loss function, into an objective function, the value of which is then minimized during the training operation 5130.

The vascular image data representing a shape of the vascular region may for example be determined from X-ray images by providing the temporal sequence of X-ray images 110 as one or more digital subtraction angiography, DSA, images.

Aspects of the training method described above may be provided by a processing arrangement comprising one or more processors configured to perform the method. The processing arrangement may for example be a cloud-based processing system or a server-based processing system or a mainframe-based processing system, and in some examples its one or more processors may include one or more neural processors or neural processing units “NPU”, one or more CPUs or one or more GPUs. It is also contemplated that the processing arrangement may be provided by a distributed computing system. The processing arrangement may be in communication with one or more non-transitory computer-readable storage media, which collectively store instructions for performing the method, and data associated therewith.

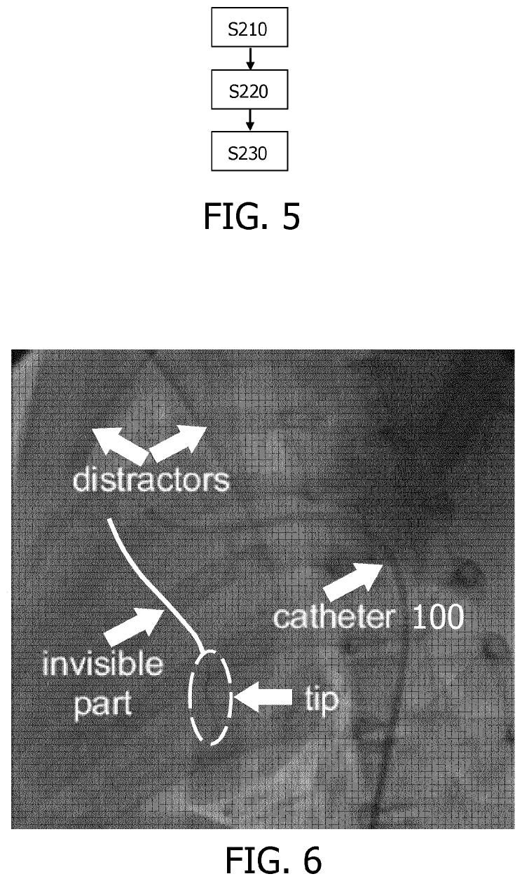

The above-described examples of the trained neural network 130 may be used to make predictions on new data in a process termed “inference”. The trained neural network may for example be deployed to a system such as a laptop computer, a tablet, a mobile phone and so forth. Inference may for example be performed by a Central Processing Unit “CPU”, a GPU, an NPU, on a server, or in the cloud. FIG. 5 is a flowchart illustrating an example method of predicting positions of portions of an interventional device, in accordance with some aspects of the disclosure. With reference to FIG. 5, a computer-implemented method of predicting a position of each of a plurality of portions of an interventional device 100, includes:
receiving 5210 temporal shape data 210 representing a shape of an interventional device 100 at a sequence of time steps and
inputting 5220 the received temporal shape data 210 representing a shape of the interventional device 100 at one or more historic time steps t₁ . . . tₙ₋₁ in the sequence, into a neural network 130 trained to predict, from the temporal shape data 210 representing a shape of the interventional device 100 at one or more historic time steps t .. 4,1 in the sequence, a position 140 of each of the plurality of portions of the interventional device 100 at a current time step tₙ in the sequence, and in response to the inputting 5220, generating 5230 a predicted position 140 of each of the plurality of portions of the interventional device 100 at the current time step tₙ in the sequence, using the neural network.

The predicted position 140 of each of the plurality of portions of the interventional device 100 at a current time step tₙ in the sequence may be outputted by displaying the predicted position 140 on a display device, or storing it to a memory device, and so forth.

As mentioned above, the temporal shape data 210 may for example include:
a temporal sequence of X-ray images including the interventional device 100; or
a temporal sequence of computed tomography images including the interventional device 100; or
a temporal sequence of ultrasound images including the interventional device 100; or
a temporal sequence of positions provided by a plurality of electromagnetic tracking sensors or emitters mechanically coupled to the interventional device 100; or
a temporal sequence of positions provided by a plurality of fiber optic shape sensors mechanically coupled to the interventional device 100; or
a temporal sequence of positions provided by a plurality of dielectric sensors mechanically coupled to the interventional device 100; or
a temporal sequence of positions provided by a plurality of ultrasound tracking sensors or emitters mechanically coupled to the interventional device 100.

The predicted position 140 of each of the plurality of portions of the interventional device 100 at a current time step tₙ in the sequence that that is predicted by the neural network 130 may be used to provide a predicted position of one or more portions of the interventional device at the current time step tₙ when the temporal shape data 210 does not clearly identify the interventional device. Thus, in one example, the temporal shape data 20 210 includes a temporal sequence of X-ray images including the interventional device 100, and the inference method includes:
displaying a current X-ray image from the temporal sequence corresponding to the current time step tₙ; and
displaying in the current X-ray image, the predicted position 140 of at least one portion of the interventional device 100 in the current X-ray image.

In so doing, the inference method alleviates drawbacks associated with the poor visibility of portions of the interventional device.

Other sources of temporal shape data 210 such as those described above during the training operation 5130 may likewise be received during inference and displayed in a corresponding manner.

By way of an example, FIG. 6 illustrates an X-ray image of the human anatomy, including a catheter and a guidewire, and wherein the predicted position of an otherwise invisible portion of the guidewire is displayed. The predicted position(s) of portion(s) of the interventional device 100 may for example be displayed in the current X-ray image as an overlay.

In some examples, a confidence score may also be computed and displayed on the display device for the displayed position of the interventional device. The confidence score may be provided as an overlay on the predicted position(s) of portion(s) of the interventional device 100 in the current X-ray image. The confidence score may for example be provided as a heat map of the probability of the device position being correct. Other forms of presenting the confidence score may alternatively be used, including displaying its numerical value, displaying a bargraph, and so forth. The confidence score may be computed using the output of the neural network, which may for example be provided by a Softmax layer at the output of each LSTM cell in FIG. 3.

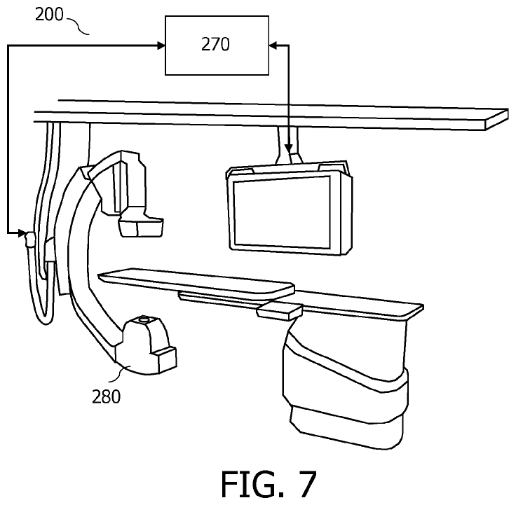

A system 200 is also provided for predicting a position of each of a plurality of portions of an interventional device 100. Thereto, FIG. 7 is a schematic diagram illustrating a system 200 for predicting positions of portions of an interventional device. The system 200 includes one or more processors 270 configured to perform one or more of the operations described above in relation to the computer-implemented inference method. The system may also include an imaging system, such as the X-ray imaging system 280 illustrated in FIG. 7, or another imaging system. In-use, the X-ray imaging system 280 may generate temporal shape data 210 representing a shape of an interventional device 100 at a sequence of time steps t₁ . . . tₙ in the form of a sequence of X-ray images, which may be used as input to the method. The system 200 may also include one or more display devices as illustrated in FIG. 7, and/or a user interface device such as a keyboard, and/or a pointing device such as a mouse for controlling the execution of the method, and/or a patient bed.

The above examples are to be understood as illustrative of the present disclosure and not restrictive. Further examples are also contemplated. For instance, the examples described in relation to the computer-implemented method, may also be provided by a computer program product, or by a computer-readable storage medium, or by a processing arrangement, or by the system 200, in a corresponding manner. It is to be understood that a feature described in relation to any one example may be used alone, or in combination with other described features, and may also be used in combination with one or more features of another of the examples, or a combination of other examples. Furthermore, equivalents and modifications not described above may also be employed without departing from the scope of the invention, which is defined in the accompanying claims. In the claims, the word “comprising” does not exclude other elements or operations, and the indefinite article “a” or “an” does not exclude a plurality. The mere fact that certain features are recited in mutually different dependent claims does not indicate that a combination of these features cannot be used to advantage. Any reference signs in the claims should not be construed as limiting their scope.

1. A computer-implemented method of training a machine-learning model for predicting positions of an interventional device, the method comprising:
receiving temporal shape data representing a shape of the interventional device at a sequence of time steps;
receiving interventional device ground truth position data representing a position of each of a plurality of portions of the interventional device at each of the time steps in the sequence; and
training the machine-learning model to predict, a position of each of the plurality of portions of the interventional device at a current time step in the sequence based on the shape of the interventional device at one or more historic time steps in the sequence from the received temporal shape data and the position of each of the plurality of portions of the interventional device at the one or more historic time steps from the received interventional device ground truth position data.

2. The computer-implemented method according to claim 1, wherein the temporal shape data, or the interventional device ground truth position data, comprises:
a temporal sequence of X-ray images including the interventional device; or
a temporal sequence of computed tomography images including the interventional device; or
a temporal sequence of ultrasound images including the interventional device ; or
a temporal sequence of magnetic resonance images including the interventional device; or
a temporal sequence of positions provided by a plurality of electromagnetic tracking sensors or emitters mechanically coupled to the interventional device ; or
a temporal sequence of positions provided by a plurality of fiber optic shape sensors mechanically coupled to the interventional device; or
a temporal sequence of positions provided by a plurality of dielectric sensors mechanically coupled to the interventional device; or
a temporal sequence of positions provided by a plurality of ultrasound tracking sensors or emitters mechanically coupled to the interventional device.

3. The computer-implemented method according to claim 1, wherein the neural network comprises a plurality of outputs, and wherein each output is configured to predict a position of a different portion of the interventional device at the current time step in the sequence.

4. The computer-implemented method according to claim 1, wherein each output is configured to predict the position of the different portion of the interventional device at the current time step in the sequence, based at least in part on the predicted position of one or more neighboring portions of the interventional device at the current time step.

5. The computer-implemented method according to claim 3, wherein the neural network comprises a LSTM neural network having a plurality of LSTM cells, and wherein each LSTM cell comprises an output configured to predict the position of a different portion of the interventional device at the current time step in the sequence; and
wherein for each LSTM cell, the cell is configured to predict the position (140) of the portion of the interventional device at the current time step in the sequence, based on the received temporal shape data representing the shape of the interventional device at the one or more historic time steps in the sequence, and the predicted position of one or more neighboring portions of the interventional device at the current time step.

6. The computer-implemented method according to claim 2, wherein the temporal shape data, or the interventional device ground truth position data, comprises a temporal sequence of X-ray images including the interventional device, and further comprising segmenting each X-ray image in the sequence to respectively provide the shape of the interventional device, or the position of each of the plurality of portions of the interventional device, at each time step.

7. The computer-implemented method according to claim 1, wherein the temporal shape data, or the interventional device ground truth position data, comprises a temporal sequence of X-ray images including the interventional device; and wherein the interventional device is disposed in a vascular region, and further comprising:
extracting, from the temporal shape data, or the interventional device ground truth position data, vascular image data representing a shape of the vascular region; and
wherein the training a neural network further comprises constraining the adjusting such that the predicted position of each of the plurality of portions of the interventional device at the current time step in the sequence, fits within the shape of the vascular region represented by the extracted vascular image data.

8. The computer-implemented method according to claim 7, wherein the temporal sequence of X-ray images comprises a digital subtraction angiography image.

9. The computer-implemented method according to claim 1, wherein the interventional device comprises at least one of: a guidewire, a catheter, an intravascular ultrasound imaging device, an optical coherence tomography device, an introducer sheath, a laser atherectomy device, a mechanical atherectomy device, a blood pressure device,. and/or flow sensor device, a TEE probe, a needle, a biopsy needle, an ablation device, a balloon, or an endograft.

10. (canceled)

11. A computer-implemented method of predicting a position of each of a plurality of portions of an interventional device, the method comprising:
receiving temporal shape data representing a shape of an interventional device at a sequence of time steps; and
predicting a position of each of the plurality of portions of the interventional device at a current time step based on the shape of the interventional device at one or more historical time steps in the sequence from the received temporal shape data.

12. The computer-implemented method according to claim 11, wherein the temporal shape data comprises a temporal sequence of X-ray images including the interventional device, and the method further comprising:
displaying a current X-ray image from the temporal sequence corresponding to the current time step; and
displaying in the current X-ray image, the predicted position of at least one portion of the interventional device in the current X-ray image.

13. The computer-implemented method according to claim 11, further comprising:
computing a confidence score for the at least one displayed position; and
displaying the computed confidence score.

14. A system for predicting a position of each of a plurality of portions of an interventional device; the system comprising one or more processors configured to perform the method according to claim 11.

15. A non-transitory computer-readable medium comprising instructions which when executed by one or more processors, cause the one or more processors to carry the method according to claim 1.

16. The computer-implemented method according to claim 1, wherein machine-learning model is a neural network that predicts each of the plurality of positions by adjusting parameters of the neural network based on a loss function representing a difference between the predicted position of each of the plurality of positions at the current time step and the position of each of the plurality of positions at the current time step from the received interventional device ground truth position data.

17. The computer-implemented method according to claim 11, wherein the position of each of the plurality of portions at the current time step is predicted by a neural network trained to predict each of the plurality of positions at the current time step based on the shape of the interventional device at the one or more historic time steps from the received temporal shape data and ground truth position data representing a position of each of a plurality of portions of the interventional device at the one or more historic time steps.
